(19) United States
(12) Patent Application Publication
(10) Pub. No.: US 2015/0134572 A1
(43) Pub. Date: May 14, 2015

(54) SYSTEMS AND METHODS FOR PROVIDING RESPONSE TO USER INPUT INFORMATION ABOUT STATE CHANGES AND PREDICTING FUTURE USER INPUT

(71) Applicant: Tactual Labs Co., New York, NY (US)

(72) Inventors: Clifton Forlines, Toronto (CA); Ricardo Jorge Jota Costa, Toronto (CA); Daniel Wigdor, Toronto (CA); Karan Singh, Toronto (CA)

(73) Assignee: TACTUAL LABS CO., New York, NY (US)

(21) Appl. No.: 14/490,363

(22) Filed: Sep. 18, 2014

Related U.S. Application Data
(60) Provisional application No. 61/879,245, filed on Sep. 18, 2013.
(60) Provisional application No. 61/880,887, filed on Sep. 21, 2013.

(51) Int. Cl. G06N 5/04; G06F 3/041

(52) U.S. Cl. CPC G06N 5/048; G06F 3/041
USPC 706/11

(57) ABSTRACT

A system and method for caching and using information about graphical and application state changes in an electronic device is disclosed. In an embodiment, the system and method utilize a model of user input from a touch sensor capable of sensing location of a finger or object above a touch surface. In the electronic device, data representative of current user input to the electronic device is created. The model of user input is applied to the data representative of current user input to create data reflecting a prediction of a future user input event. That data is used to identify at least one particular response associated with the predicted future user input event. Data useful to implement graphical and application state changes is cached in a memory of the electronic device, the data including data reflecting a particular response associated with the predicted future user input. The cached data is retrieved from the memory of the electronic device and is used the data to implement the state changes.

This application is a non-provisional of and claims priority to U.S. Provisional Patent Application No. 61/879,245 filed Sep. 18, 2013 and U.S. Provisional Patent Application No. 61/880,887 filed Sep. 21, 2013, the entire disclosures of which are incorporated herein in their entirety. This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

This application relates to fast multi-touch sensors such as those disclosed in U.S. patent application Ser. No. 13/841,436 filed Mar. 15, 2013 entitled “Low-Latency Touch Sensitive Device,” U.S. Patent Application No. 61/798,948 filed Mar. 15, 2013 entitled “Fast Multi-Touch Stylus,” U.S. Patent Application No. 61/799,035 filed Mar. 15, 2013 entitled “Fast Multi-Touch Sensor With User-Identification Techniques,” U.S. Patent Application No. 61/798,828 filed Mar. 15, 2013 entitled “Fast Multi-Touch Noise Reduction,” U.S. Patent Application No. 61/798,708 filed Mar. 15, 2013 entitled “Active Optical Stylus,” U.S. Patent Application No. 61/710,256 filed Oct. 5, 2012 entitled “Hybrid Systems And Methods For Low-Latency User Input Processing And Feedback” and U.S. Patent Application No. 61/845,892 filed Jul. 12, 2013 entitled “Fast Multi-Touch Post Processing.” The entire disclosures of those applications are incorporated herein by reference.

This Application includes an appendix consisting of 10 pages entitled “Planes on a Snake: a Model for Predicting Contact Location Free-Space Pointing Gestures,” which is incorporated into and part of the present disclosure.

### FIELD

The present invention relates in general to the field of user input, and in particular to systems and methods that include a facility for predicting user input.

### BRIEF DESCRIPTION OF THE DRAWINGS

Features and advantages of the disclosed systems and methods will be apparent from the following more particular description of embodiments as illustrated in the accompanying drawings, in which reference characters refer to the same parts throughout the various views. The drawings are not necessarily to scale, emphasis instead being placed upon illustrating principles of the disclosed embodiments.

FIG. 1 is a three-dimensional graph illustrating modeling of pre-touch data.

FIG. 2 is a three-dimensional graph illustrating actual pre-touch data.

FIG. 3 is a three-dimensional graph illustrating an example of a liftoff step.

FIG. 4 is a three-dimensional graph illustrating an example of a corrective approach step.

FIG. 5 is a three-dimensional graph illustrating an example of a drop-down or ballistic step.

### DETAILED DESCRIPTION

The following description and drawings are illustrative and are not to be construed as limiting. Numerous specific details are described to provide a thorough understanding. However, in certain instances, well-known or conventional details are not described in order to avoid obscuring the description. References to one or an embodiment in the present disclosure are not necessarily references to the same embodiment; and, such references mean at least one.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Throughout this disclosure, the terms “touch”, “touches,” “contact,” “contacts” or other descriptors may be used to describe the periods of time in which a user's finger, a stylus, an object or a body part is detected by the sensor. In some embodiments, these detections occur only when the user is in physical contact with a sensor, or a device in which it is embodied. In other embodiments, the sensor may be tuned to allow the detection of “touches” or “contacts” that are hovering a fixed distance above the touch surface. Therefore, the use of language within this description that implies reliance upon sensed physical contact should not be taken to mean that the techniques described apply only to those embodiments; indeed, nearly all, if not all, of what is described herein would apply equally to “touch” and “hover” sensors.

End-to-end latency, the total time required between a user's input and the presentation of the system's response to that input, is a known limiting factor in user performance. In direct-touch systems, because of the collocation of the user's input and the display of the system's response, latency is especially apparent. Users of such systems have been found to have impaired performance under as little as 25 ms of latency, and can notice the effects of even a 2 ms delay between the time of a touch and the system's response.

Actual latency as used herein refers to the total amount of time required for a system to compute and present a response to a user selection or input. Actual latency is endemic to interactive computing. As discussed herein, there is a substantial potential to reduce actual latency if predictive methods are used to anticipate the position of user inputs and user states. Such predictions, if sufficiently accurate, may permit a system to respond to an input, or begin responding, before, or concurrently with, the input itself Timed correctly, a system's response to a predicted input can be aligned with the actual moment of a user's actual input if it was correctly predicted. Moreover, if the user's actual input was sufficiently correctly predicted, the time required for a system's response to the predicted input can be reduced. In other words, the time between the user's actual selection and the system's response to that actual selection can be less than the actual latency. While this does not reduce the total amount of time required to respond to the predicted input, i.e., actual latency, it does reduce the system's apparent latency, that is, the total amount of time between the actual input and the system's response to the actual input.

In an embodiment, the disclosed system and method provides faster response to user input by intelligently caching information about graphical state changes and application state changes through predicting future user input. By sensing the movement of a user's finger(s)/hands/pen when it is in contact with the touch surface and while it is “hovering” above the touch surface, the disclosed systems and methods can—with a degree of accuracy—predict future input events, such as the location of a future touch, by applying a model of user input. The model of user input uses current and previous input events to predict future input events. For example, by looking at the path of a finger through the air above a touch screen, the disclosed systems and methods can—with some degree of accuracy—predict the location that the finger will make contact with the display. In an embodiment, prediction about future user input is paired with software or hardware that prepares the user interface and application state to respond quickly to the predicted input in the event that it occurs.

Using a fast touch sensor which is capable of sensing finger/pen location above the touch surface (in addition to sensing when the finger/pen is in contact with the surface), the disclosed system and method can predict future input events with some degree of accuracy. The high-speed, low-latency nature of such input devices may provide ample and timely input events to make these predictions. Predicted input events can include, but are not limited to, touchdown location (location where a finger/pen/hand/etc. will make contact with the display), touchup location (position where finger/pen/etc. will be lifted from the display), single or multi-finger gestures, dragging path, and others. Predicted events are discussed in further detail below.

In an embodiment, in addition to location information, the predicted input events may include a prediction of timing, that is, when the event will be made.

In an embodiment, predicted input events may additionally include a measure of probability (e.g., between 0% and 100%) indicating the confidence that the model associates with the predicted event. As such, in an embodiment, a model can predict multiple future events, and assign a probability to each of them indicating the likelihood of their actual occurrence in the future.

In an embodiment, predicted events may be paired with system components that prepare the device or application for those future events. For example, an “Open . . . ” button in a GUI could pre-cache the contents of the current directory when the predicted events from the model indicate that the “Open” button was likely to be pressed. In this example, the GUI may be able to show the user the contents of the current directory faster because of the pre-caching than it would be able to had no prediction occurred. As another example, consider a “Save” button in a GUI that has two visual appearances, pressed and unpressed. Using the technique described in this application, if a model predicts that the user will press this button, the software could pre-render the pressed appearance of the “Save” button so that it is able to quickly render this appearance once the input event is actually performed. In the absence of the systems and methods described herein, software may wait until the input event occurs before rendering the pressed appearance, resulting in a longer delay between input event and graphical response to that input. In an embodiment, the user input event is a temporary conclusion of interaction by the user and the cached data consists of commands to put the device into a low power mode. In this manner, the device can be configured to predict that the user will not touch the touch interface again or will pause before the next touch, and save substantial power by throttling down parts of the device. In an embodiment, the model and prediction of touch location are used to correct for human error on touch. For example, when pressing a button that is near other buttons, the finger approach and model can be used by the processor to determine that the user intended to hit the button on the left but instead hit the left edge of the button on the right.

### Modeling

While certain specific modeling techniques are discussed herein, other techniques that take as an input a vector of previous input events and outputs one or more future input events may be compatible with this invention.

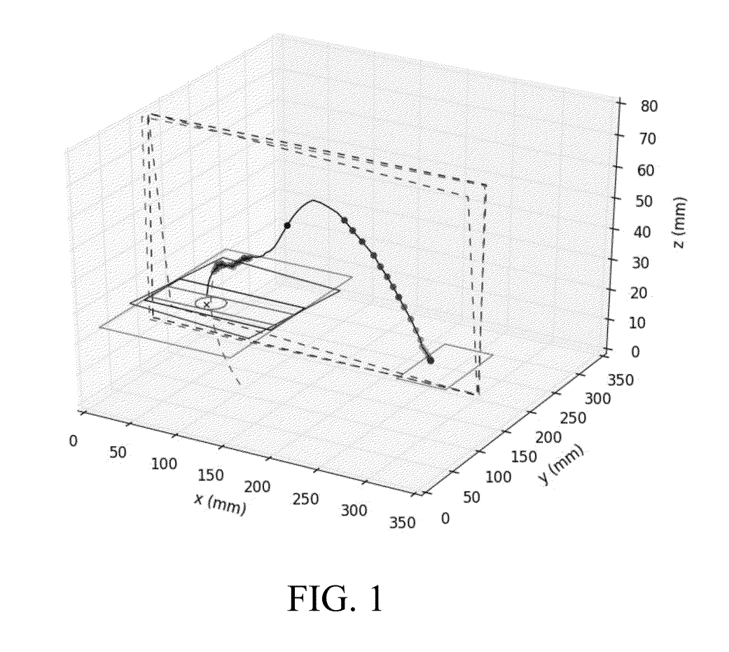

Using data collected from a high-fidelity tracking system, a model of the movement of user's finger is constructed. The model allowed outputs one or more predicted locations and one or more predicted timings of a touch by the finger. As shown in FIG. 1, in an embodiment, pre-touch data (in black) is modeled. In an embodiment, the modeling involves three main steps: the initial rise (in red), a corrective movement towards the target (in blue), and a final drop down action (in green). In an embodiment, for each step a plane is fit, and the plane is projected onto the touch surface. The intersection of the projected plane and the touch surface may be used to provide a region of probably touch position. As shown in FIG. 1, in an embodiment, the initial rise may yield a larger region of probability (red rectangle), the corrective movement may yield a smaller region (blue rectangle) and the final drop down action may yield an even smaller region (green rectangle). In an embodiment, with respect to the final drop down action, the prediction may be narrowed by fitting a parabola to the approach data. As illustrated in FIG. 1, in an embodiment, the model is adaptive, in that it may provide an increasingly narrow region of likely touch events as the user's gesture continues towards the screen.

The data collected to form the model, and, indeed, the model's application to predicting touch location, require a high-fidelity tracking touch device. In an embodiment, such high-fidelity tracking may require sensing capabilities beyond those of typical modern touch devices though not beyond those of typical stylus-tracking technologies. In an embodiment, such high-fidelity tracking may require sensing capabilities that are too expensive today for commercial implementation in common devices, but are likely to be incorporated into common devices in the near future. In an embodiment, such high-fidelity tracking may require a combination of sensors including, e.g., using the combined fidelity of separate inputs such as video input and capacitive input.

While the sensing capabilities utilized by the model disclosed herein are typically referred to as ‘hover’, such input stream is more accurately re-termed as “pre-touch” to make the distinction between its use for predicting touch locations, and any kind of hover-based feedback (visual or otherwise) which might be presented to the user, or any hover-based interaction techniques.

In an embodiment, pre-touch information is used to predict user actions for computing devices, and particularly user actions for mobile devices such as touch pads and smart phones. Specifically, in an embodiment, pre-touch information may be used to predict where, and when, the user is going to touch a device.

### Observations

Participants executed the data collection study using two touch devices, constrained to a surface. In the center of the tablet, a 10-inch tablet was responsible for the trial elements and user feedback. This was the main surface, where participants were required to execute the trial actions. The gesture starting position is important to the approach, defining the horizontal angle of attack. To control for this angle, we asked participants to start all gestures from a phone, positioned between the user and the tablet. To start a trial, the participant was required to touch and hold the phone display until an audio feedback indicated the trial start. Both phone and tablet were centered to the user position and positioned 13 cm and 30 cm from edge of the table.

To interact with the two devices the participants used an artifact (pen or glove) tracked by a marker tracking system that was tracking an area of 2 cubic meters centered on the tablet display. This system provides 3D position and rotation of the artifact tracked every 120 ms, with this information we can calculate the finger or pen tip position in 3D space.

The devices and the marker tracking system were connected to a PC, which controlled the flow of the experiment. The computer ran a Python application designed to: (1) read the position and rotation of the artifact; (2) receive touch down and up from tablet and phone; (3) issue commands to the tablet; and (4) log all the data. The computer was not responsible for any touch or visual feedback; all visuals were provided by the tablet.

For each action, the participant was required to touch, and hold the phone display, which triggered the system to advance to the next trial, shown on the tablet display. To control for hunting-and-seek motions, users were requested to wait for an acoustic feedback, output by the phone and randomly triggered between 0.7 and 1 second after the feedback was displayed. The task consisted of tapping a specified location, following a straight or elbow path, or following instructions to draw simple shapes. Once the trial was executed, the users were instructed to return to the phone, to indicate that the trial was finished, and wait for the acoustic feedback to start the next trial. Any erroneous task was repeated, with feedback indicating failure provided by the tablet.

Participants completed a consent form and a questionnaire to collect demographic information. They then received instruction on how to interact with the apparatus, and completed 30 training trials to practice the acoustic feedback, the task requested and the overall flow of the trials.

After the execution of each trial, a dialog box appeared to indicate the result (‘successful’ or ‘error’) and the cumulative error rate (show as a %). Participants were instructed to slow down if the error rate was above 5%, but were not instructed regarding the pre-touch movement. Once a trial was concluded, the next trial would be displayed on the tablet, and the acoustic feedback provided to indicate trial start. The procedure lasted approximately 15 minutes and the entire session was conducted in around 1 hour.

Tasks were designed accordingly to three independent variables: starting position (9 starting positions for gestures and 5 for tapping, evenly distributed in the tablet surface), action type (tap, gestures and draw actions) and direction (left, right, up, down). We studied 6 drawing actions, 144 gestures and 5 tapping locations to a total of 155. Participants executed the tasks using either a pen artifact or a finger glove.

Each participant performed 6 repetitions of touch actions, 2 for each gesture combination of position and direction, and once for draw actions for a total of 330 actions per study. The ordering of the trials was randomized across participants. Participants were required to execute two sessions, one using a pen artifact and another tracking the finger. The ordering for the two sessions was round-robin between participants.

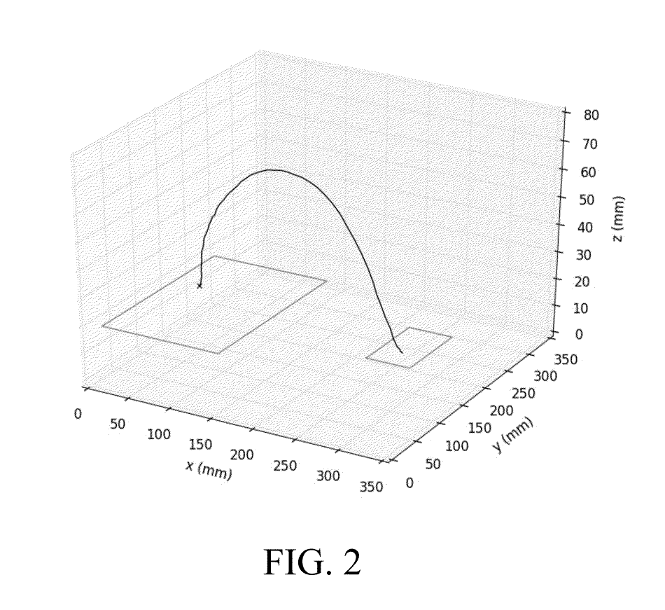

In summary, 18 participants performed 660 trials each, totaling in 11,880 trials. FIG. 2 shows an example of data collected for a single trial. In black are all the pre-touch points, starting on the phone position and ending on the target position on the tablet. The purple X represents the registered touch point in the tablet display.

For each trial we captured the total completion time; artifact position, rotation, and timestamp for each position; when the participant was touching the tablet (from the marker tracking system and the tablet own input even stream); and the result of each trial. Trials that were repetitions of erroneous trials were assigned as such. Trials were then analyzed for the number of outliners in artifact position (due to tracking misplacements of the artifact) and trials with 80%, or above, of accurate tracking were used for analysis. Of those, all classified outliers were discarded. Based on the rate of the tracking system (120 ms) and the speed of the gestures, any event that was more than 3.5 cm away from its previous neighbor was considered an outlier.

Out of the acceptable trials, we selected the finger tap actions to use as basis to create a model. This divided the acceptable trials into 500 trials used as a “training set” and leaves the remaining trials to validate our approach.

To create the model we set out to observe the 500 selected trials and identify what steps the majority of the movements express. In this section we describe the model that we created, based on these observations. All spatial references are in relation to the x,y,z reference space based on the top-right of the tablet, similar to the x,y reference space common in touch frameworks. In our case, z is the vertical distance to the display.

### Liftoff, Correction and Drop-Down

The data so collected revealed a distinctive three-phase gesture approach that can be divided into three main components that we refer to as: the liftoff, the corrective approach and the drop-down. In addition to these steps, to define the model, three identifiable velocity elements were also included: top overall speed, initial descent and final descent.

### Top Speed, Initial Descent and Final Descent

The data collected also revealed that the pre-touch approach approaches a ballistic movement, where the finger reaches a maximum vertical distance to the display and starts dropping down to the target.

Looking at the data reflective of overall speed one can identify when the movement reaches its top-speed. The collected data revealed that the top speed is achieved halfway through the motion and both the acceleration and de-acceleration can be fitted by lines. In an embodiment, this information may be used to identify when the liftoff step is terminated, and/or when to start to look for an initial descent.

The initial descent is defined as the point when the finger starts vertically moving towards the touch display. In an embodiment, initial descent may be identified by determining when the finger's acceleration, in the z values, crosses a zero value. Even when the acceleration crosses a zero, however, such change in acceleration is not necessarily indicative that the finger with accelerate towards the display without further adjustments. Rather, it has been discovered that, it is often the case, there is a de-acceleration before a final descent is initiated. In an embodiment, this detail provides fundamental information as to when the touch is going to happen, and is indicative of the final drop-down, ballistic, step. In an embodiment, these cues help detect each of the three steps described next.

Modeling Touch Approach

In an embodiment, a model, comprised of three steps, successfully generalizes the touch approach to a surface of interest.

Liftoff

The liftoff is defined as the portion of a movement where the user starts moving the finger away from the display. It is characterized by an increase in vertical, upward, speed and direction towards the target. While the direction of the liftoff is not always directly aligned with the target, often requires a corrective approach, a plane minimized to fit the liftoff data and intersecting the tablet is enough to create a prediction of the location (i.e., a predicted region) of a touch event, very early on, and thus, also, to predict a low likelihood of touch in some parts of the display.

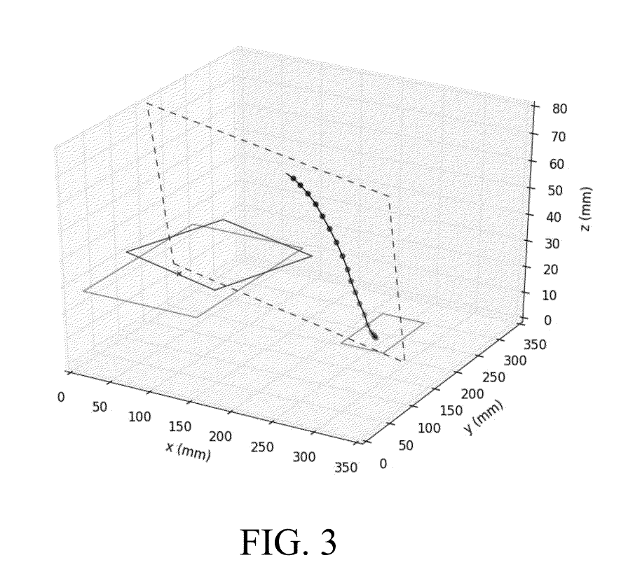

FIG. 3 shows an example of a liftoff step. In this example, the rise is fit by a plane that is slightly deviated, from the target, to the left. During liftoff, movement may be fast and in the general direction of the target, but may require future corrections.

Corrective Approach

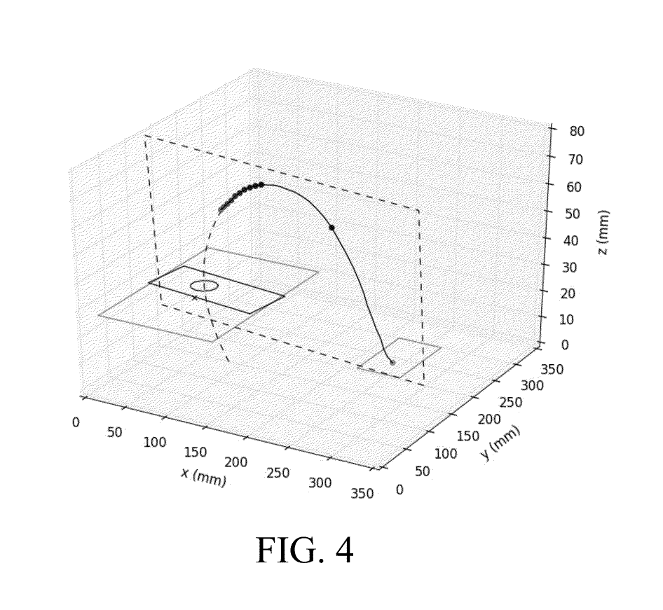

FIG. 4 shows an example of the corrective approach step. In this example, the correction is compensating for the liftoff deviation. In an embodiment, a model may accounts for this deviation by fitting a new plane and reducing the predictive touch area.

The corrective approach is characterized by an inversion in vertical velocity; this is because the finger is beginning its initial descent towards the target. A slight decrease in the overall velocity may be observed; given the significant reduction of vertical velocity, such a decrease may suggest that the horizontal velocity is increasing, thus compensating for the slowdown in vertical velocity. This effect is believed to be a result of the finger is moving away from the plane defined during liftoff, as it corrects its path toward the target. In an embodiment, a second plane is fit to the data points that deviate from the liftoff defined plane. In an embodiment, the model may presume that the deviation of the surface intersection of plane formed from corrective data with respect to the surface intersection of the plane formed from liftoff data has a strong correlation to final target position. For example, if a deviation to the left of the liftoff plane is observed, the right side of the liftoff plane can be disregarded and the target is also to the left of the liftoff plane.

Drop-Down

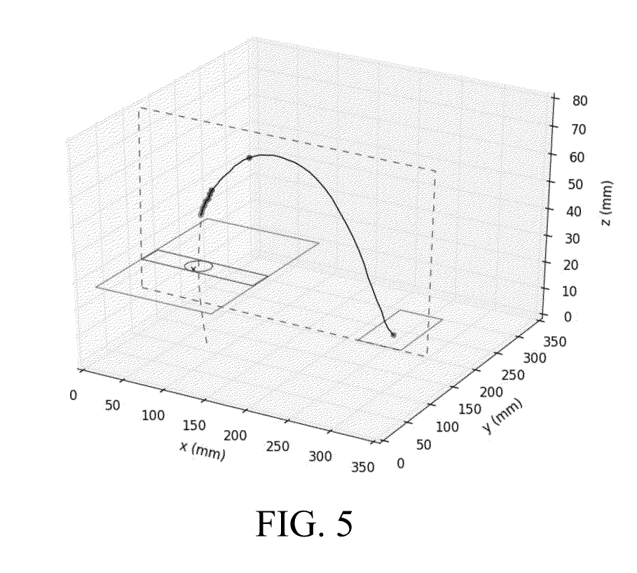

As shown in FIG. 5, a rapid downward movement indicates that the third step, the drop-down or ballistic step, has been reached. In an embodiment, a third plane (i.e., ballistic plan) is fit to the data from the drop-down step. The third plane may account for deviation from the corrective approach plane, and in an embodiment, attempts to fit a parabola to the drop-down/ballistic event. In an embodiment, during the ballistic step, the model may accurately predict a touch event with some degree of likelihood. In an embodiment, the model may be used to predict the touch (to a very high degree of likelihood), within a circle of 1.5 cm in radius, from a vertical distance of 2.5 cm. In an embodiment, the model may be used to accurately predict a non-interrupted touch (e.g., without a change in the user's desire, and without an external event that may move the surface) within a circle of 1.5 cm in radius, from a vertical distance of 2.5 cm.

In the drop-down step, the finger is relatively close to the tablet, speeding up towards the target. The finger may be speeding up due to the force of gravity, or by the user employing a final adjustment that speeds up the finger until touching the display. In either event, this drop-down or ballistic step is characterized by a significant increase in vertical velocity and may be accompanied by a second deviation from the corrective approach.

The ballistic step is the last step of the pre-touch movement, it is the step during which, if completed, the user will touch the display. The movement during the ballistic step may also be fit to a plane. In an embodiment, the ballistic step movement is fit to a plane where a material deviation from the corrective approach plane is detected. The plane is fitted to the data points that deviate from the corrective plane. In an embodiment, the ballistic step movement is modeled as a parabola to further reduce the size of the probable area of touch. In an embodiment, to model the ballistic step as a parabola in order to further reduce the prediction, the following constraints are used: the parabola is constrained to the current plane (i.e., the ballistic plane); it follows the direction of the available data points; on z=0, the parabola tangent is assumed perpendicular to the tablet display.

These three predictions create a system of linear equations with a single solution. How accurate the parabola predicts the touch point depends on how soon the parabola is fitted to the data points; the later in the gesture the parabola is fitted, the more likely it is that its fit will be closer to the actual touch point and, therefore, the better the prediction.

Although one example was provided above, other predictions and states can be modeled. Examples of predictions and states that can be modeled include, e.g., the moment at which a touch or other event will occur, the location of the touch or other event, a confidence level associated with the predicted touch or other event, an identification of which gesture is being predicted, an identification of which hand is being used, an identification of which arm is being used, handedness, an estimate of how soon a prediction can be made, user state (including but not limited to: frustrated, tired, shaky, drinking, intention of the user, level of confusion, and other physical and psychological states), a biometric identification of which of multiple users is touching the sensor (e.g., which player in a game of chess), orientation or intended orientation of the sensor, landscape vs. portrait. Such predictions and states can be used not only to reduce latency but in other software functions and decision making. For example, the trajectory of the user's finger from the “T” key toward the “H” key on a virtual keyboard that is displayed on the sensor can be used to compare the currently typed word to a dictionary to increase the accuracy of predictive text analysis (e.g., real time display of a word that is predicted while a user is typing the word). Such trajectory can also be used, e.g., to increase the target size of letters that are predicted to be pressed next. Such trajectory may be interpreted in software over time to define a curve that is used by the model for prediction of user input location and time. The predictions and states described above can be also used in software to reject false positives in software interpretation of user input.

Using the model and prediction to better map between the contact area of a finger and a pixel on the display. In touch devices, the sensor senses an area corresponding to the contact area between finger and display. This pad is mapped to a pixel in one of many ways, such as picking the centroid, center of mass, top of bounding box, etc. The predictive model as described above can be used to inform the mapping of contact area to pixels based on information about the approach and the likely shape of the finger pressing into the screen. The contact area does not always coincide with the intended target. Models have been proposed that attempt to correct this difference. The availability of pre-touch as described above can be used to educate the models by not only providing the contact area but also distinguishing touches that are equivalently sensed yet have distinct approaches. For example, a trajectory with a final approach arching from the left might be intended for a target left of the initial contact, where an approach with a strong vertical drop might be intended for the target closest to the fingernail. The shape of the contact (currently, uniquely based on the touch sensed region) might also benefit from the approach trajectory. For example, as a user gestures to unlock a mobile device, the sensed region of the finger shifts slightly, due to the angle of attack on touch-down. Data concerning how the finger approaches can be used to understand the shifts of contact shape and determine if they are intentional (finger rocking) or just secondary effects of a fast approach that initiates a finger roll after touch-down. Finally, the model predictions described above indicate where the user is most likely going to touch and what regions of the display are not likely to receive touches. One problem of touch technology is palm rejection—i.e: how does a system decide when a touch is intentional versus when a touch is a false positive, due to hand parts other than the finger being sensed. Once a prediction is made, any touch recognized outside the predicted area can be safely classified as a false positive and ignored. This effectively allows the user to rest her hand on the display or ever train the sensor to differentiate between an approach intended to grasp the device (low approach from the side) or a tap (as described by our data collection).

The present invention is described above with reference to block diagrams and operational illustrations of methods and devices to provide response to user input using information about state changes and predicting future user input. It is understood that each block of the block diagrams or operational illustrations, and combinations of blocks in the block diagrams or operational illustrations, may be implemented by means of analog or digital hardware and computer program instructions. These computer program instructions may be stored on computer-readable media and provided to a processor of a general purpose computer, special purpose computer, ASIC, or other programmable data processing apparatus, such that the instructions, which execute via the processor of the computer or other programmable data processing apparatus, implements the functions/acts specified in the block diagrams or operational block or blocks. In some alternate implementations, the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved.

At least some aspects disclosed can be embodied, at least in part, in software. That is, the techniques may be carried out in a special purpose or general purpose computer system or other data processing system in response to its processor, such as a microprocessor, executing sequences of instructions contained in a memory, such as ROM, volatile RAM, non-volatile memory, cache or a remote storage device.

Routines executed to implement the embodiments may be implemented as part of an operating system, firmware, ROM, middleware, service delivery platform, SDK (Software Development Kit) component, web services, or other specific application, component, program, object, module or sequence of instructions referred to as “computer programs.” Invocation interfaces to these routines can be exposed to a software development community as an API (Application Programming Interface). The computer programs typically comprise one or more instructions set at various times in various memory and storage devices in a computer, and that, when read and executed by one or more processors in a computer, cause the computer to perform operations necessary to execute elements involving the various aspects.

A non-transitory machine-readable medium can be used to store software and data which when executed by a data processing system causes the system to perform various methods. The executable software and data may be stored in various places including for example ROM, volatile RAM, non-volatile memory and/or cache. Portions of this software and/or data may be stored in any one of these storage devices. Further, the data and instructions can be obtained from centralized servers or peer-to-peer networks. Different portions of the data and instructions can be obtained from different centralized servers and/or peer-to-peer networks at different times and in different communication sessions or in a same communication session. The data and instructions can be obtained in entirety prior to the execution of the applications. Alternatively, portions of the data and instructions can be obtained dynamically, just in time, when needed for execution. Thus, it is not required that the data and instructions be on a machine-readable medium in entirety at a particular instance of time.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks (DVDs), etc.), among others.

In general, a machine readable medium includes any mechanism that provides (e.g., stores) information in a form accessible by a machine (e.g., a computer, network device, personal digital assistant, manufacturing tool, any device with a set of one or more processors, etc.).

In various embodiments, hardwired circuitry may be used in combination with software instructions to implement the techniques. Thus, the techniques are neither limited to any specific combination of hardware circuitry and software nor to any particular source for the instructions executed by the data processing system.

The above embodiments and preferences are illustrative of the present invention. It is neither necessary, nor intended for this patent to outline or define every possible combination or embodiment. The inventors have disclosed sufficient information to permit one skilled in the art to practice at least one embodiment of the invention. The above description and drawings are merely illustrative of the present invention and that changes in components, structure and procedure are possible without departing from the scope of the present invention as defined in the following claims. For example, elements and/or steps described above and/or in the following claims in a particular order may be practiced in a different order without departing from the invention. Thus, while the invention has been particularly shown and described with reference to embodiments thereof, it will be understood by those skilled in the art that various changes in form and details may be made therein without departing from the spirit and scope of the invention.

What is claimed is:

1. A method for caching and using information about graphical state changes in an electronic device, the method comprising:
storing a model of user input from a touch sensor capable of sensing location of a finger or object above a touch surface;
creating in the electronic device data representative of current user input to the electronic device;
applying the model of user input to the data representative of current user input to create data reflecting a prediction of a future user input event;
using the data reflecting the prediction of the future user input event to identify at least one particular response associated with the at least one predicted future user input event;
caching in a memory of the electronic device data useful to implement graphical state changes, the data comprising data reflecting at least one particular response associated with the predicted future user input;
retrieving the cached data reflecting the at least one particular response from the memory of the electronic device and using the data to implement at least one of the graphical state changes.

2. The method of claim 1, wherein the data reflecting the at least one particular response is retrieved from the memory of the electronic device in response to the predicted user input event.

3. The method of claim 1, wherein the data reflecting the at least one particular response is retrieved from the memory of the electronic device prior to the predicted user input event.

4. The method of claim 1, wherein the steps of retrieving the cached data and using the data are implemented in hardware integrated with the electronic device.

5. The method of claim 1, wherein the steps of retrieving the cached data and using the data are implemented in software running on the electronic device.

6. The method of claim 1, wherein the prediction of a future user input event comprises a prediction of a location of a touchdown.

7. The method of claim 1, wherein the prediction a future user input event comprises a prediction of a location of a touchup.

8. The method of claim 1, wherein the prediction of a future user input event comprises a prediction of a gesture.

9. The method of claim 8, wherein the gesture comprises a multi-finger gesture.

10. The method of claim 1, wherein the prediction of a future user input event comprises a prediction of a dragging path.

11. The method of claim 1, wherein the prediction of a future user input event comprises a prediction of timing of the future user input.

12. The method of claim 1, wherein the prediction of a future user input event comprises one or more measures of probability indicative of confidence that the model associates with the predicted future event.

13. The method of claim 12, wherein the one or more measures of probability comprise a measure of probability that the future user input event will occur at a particular location and a measure of probability that the future user input event will occur at a particular time or time frame.

14. The method of claim 12, wherein the one or more measures of probability are used to determine data to be cached.

15. The method of claim 1, wherein the object is a stylus.

16. The method of claim 1, wherein the model is stored in the device as a table.

17. The method of claim 1, wherein the model comprises a model of a liftoff phase.

18. The method of claim 1, wherein the model comprises a model of a correction phase.

19. The method of claim 1, wherein the model comprises a model of a drop-down phase.

20. The method of claim 1, wherein the model utilizes changes in speed of the motion of the finger or object.

21. A method for caching and using information about application state changes in an electronic device, the method comprising:
storing a model of user input from a touch sensor capable of sensing location of a finger or object above a touch surface;
creating in the electronic device data representative of current user input to the electronic device;
applying the model of user input to the data representative of current user input to create data reflecting a prediction of a future user input event;
using the data reflecting the prediction of the future user input event to identify at least one particular response associated with the at least one predicted future user input event;
caching in a memory of the electronic device data useful to implement application state changes, the data comprising data reflecting at least one particular response associated with the predicted future user input;
retrieving the cached data reflecting the at least one particular response from the memory of the electronic device and using the data to implement at least one of the application state changes.

22. The method of claim 21, wherein the data reflecting the at least one particular response is retrieved from the memory of the electronic device in response to the predicted user input event.

23. The method of claim 21, wherein the data reflecting the at least one particular response is retrieved from the memory of the electronic device prior to the predicted user input event.

24. The method of claim 21, wherein the steps of retrieving the cached data and using the data are implemented in hardware integrated with the electronic device.

25. The method of claim 21, wherein the steps of retrieving the cached data and using the data are implemented in software running on the electronic device.

26. The method of claim 21, wherein the prediction of a future user input event comprises a prediction of a location of a touchdown.

27. The method of claim 21, wherein the prediction a future user input event comprises a prediction of a location of a touchup.

28. The method of claim 21, wherein the prediction of a future user input event comprises a prediction of a gesture.

29. The method of claim 28 wherein the gesture comprises a multi-finger gesture.

30. The method of claim 21, wherein the prediction of a future user input event comprises a prediction of a dragging path.

31. The method of claim 21, wherein the prediction of a future user input event comprises a prediction of timing of the future user input.

32. The method of claim 21, wherein the prediction of a future user input event comprises one or more measures of probability indicative of confidence that the model associates with the predicted future event.

33. The method of claim 32, wherein the one or more measures of probability comprise a measure of probability that the future user input event will occur at a particular location and a measure of probability that the future user input event will occur at a particular time or time frame.

34. The method of claim 32, wherein the one or more measures of probability are used to determine data to be cached.

35. The method of claim 21, wherein the object is a stylus.

36. The method of claim 21, wherein the model is stored in the device as a table.

37. The method of claim 21, wherein the model comprises a model of a liftoff phase.

38. The method of claim 21, wherein the model comprises a model of a correction phase.

39. The method of claim 21, wherein the model comprises a model of a drop-down phase.

40. The method of claim 21, wherein the model utilizes changes in speed of the motion of the finger or object.

41. A method for caching and using information that prepares a device or application for at least one future event, the method comprising:
storing a model of user input from a touch sensor capable of sensing location of a finger or object above a touch surface;
creating in the electronic device data representative of current user input to the electronic device;
applying the model of user input to the data representative of current user input to create data reflecting a prediction of a future user input event;
using the data reflecting the prediction of future user input to identify data useful to prepare the device or application for at least one particular event;
caching in a memory of the electronic the device data useful to prepare the device or application for at least one future event, the data comprising data useful to prepare the device or application for at least one particular event; and,
retrieving the cached data from the memory in the electronic device.

42. The method of claim 41, wherein the device or application is a user interface element of a graphical user interface.

43. The method of claim 41, wherein the particular user input event comprises a temporary conclusion of interaction by the user and the cached data comprises commands to put the device into a low power mode.

44. The method of claim 42, wherein the interface element is a button, the particular event is a press of the button, and the cached data is a pre-rendering of an appearance of the button.

45. The method of claim 42, wherein the interface element is an open button, the particular event is a press of the button, and the cached data is the contents of a current directory.

46. The method of claim 41, wherein the cached data is retrieved from the memory of the electronic device in response to the predicted user input event.

47. The method of claim 41, wherein the cached data is retrieved from the memory of the electronic device prior to the predicted user input event.

48. The method of claim 41, wherein the steps of retrieving the cached data and using the data are implemented in hardware integrated with the electronic device.

49. The method of claim 41, wherein the steps of retrieving the cached data and using the data are implemented in software running on the electronic device.

50. The method of claim 41, wherein the prediction of a future user input event comprises a prediction of a location of a touchdown.

51. The method of claim 41, wherein the prediction a future user input event comprises a prediction of a location of a touchup.

52. The method of claim 41, wherein the prediction of a future user input event comprises a prediction of a gesture.

53. The method of claim 52, wherein the gesture comprises a multi-finger gesture.

54. The method of claim 41, wherein the prediction of a future user input event comprises a prediction of a dragging path.

55. The method of claim 41, wherein the prediction of a future user input event comprises a prediction of timing of the future user input.

56. The method of claim 41, wherein the prediction of a future user input event comprises one or more measures of probability indicative of confidence that the model associates with the predicted future event.

57. The method of claim 56, wherein the one or more measures of probability comprise a measure of probability that the future user input event will occur at a particular location and a measure of probability that the future user input event will occur at a particular time or time frame.

58. The method of claim 47, wherein the one or more measures of probability are used to determine data to be cached.

59. The method of claim 41, wherein the object is a stylus.

60. The method of claim 41, wherein the model is stored in the device as a table.

61. The method of claim 41, wherein the model comprises a model of a liftoff phase.

62. The method of claim 41, wherein the model comprises a model of a correction phase.

63. The method of claim 41, wherein the model comprises a model of a drop-down phase.

64. The method of claim 41, wherein the model utilizes changes in speed of the motion of the finger or object.

65. A low-latency touch sensitive device comprising:
a. a touch sensor capable of sensing location of a finger or object above a touch surface and creating data representative of current user input to the electronic device;
b. a memory having stored therein a model of user input from the touch sensor;
c. a processor configured to:
i. apply the model of user input to the data representative of current user input to create data reflecting a prediction of a future user input event;
ii. use the data reflecting the prediction of the future user input event to identify at least one particular response associated with the at least one predicted future user input event;
iii. cache in memory data useful to implement graphical state changes, the data comprising data reflecting at least one particular response associated with the predicted future user input; and,
iv. retrieve the cached data reflecting the at least one particular response from the memory of the electronic device and use the data to implement at least one of the graphical state changes.

66. The low-latency touch sensitive device of claim 65, wherein the processor is configured to retrieve the cached data from the memory of the electronic device in response to the predicted user input event.

67. The low-latency touch sensitive device of claim 65, wherein the processor is configured to retrieve the cached data from the memory of the electronic device prior to the predicted user input event.

68. The low-latency touch sensitive device of claim 65, wherein the device comprises hardware configured to retrieve the cached data and use the data.

69. The low-latency touch sensitive device of claim 65, wherein the device comprises software configured to retrieve the cached data and use the data.

70. The low-latency touch sensitive device of claim 65, wherein the processor is configured to predict a location of a touchdown.

71. The low-latency touch sensitive device of claim 65, wherein the processor is configured to predict a location of a touchup.

72. The low-latency touch sensitive device of claim 65, wherein the processor is configured to predict a gesture.

73. The low-latency touch sensitive device of claim 72, wherein the gesture comprises a multi-finger gesture.

74. The low-latency touch sensitive device of claim 65, wherein the processor is configured to predict a dragging path.

75. The low-latency touch sensitive device of claim 65, wherein the processor is configured to predict timing of the future user input.

76. The low-latency touch sensitive device of claim 65, wherein the processor is configured to compute one or more measures of probability indicative of confidence that the model associates with the predicted future event.

77. The low-latency touch sensitive device of claim 76, wherein the one or more measures of probability comprise a measure of probability that the future user input event will occur at a particular location and a measure of probability that the future user input event will occur at a particular time or time frame.

78. The low-latency touch sensitive device of claim 76, wherein the one or more measures of probability are used to determine data to be cached.

79. The low-latency touch sensitive device of claim 65, wherein the object is a stylus.

80. The low-latency touch sensitive device of claim 65, wherein the model is stored in the device as a table.

81. The low-latency touch sensitive device of claim 65, wherein the model comprises a model of a liftoff phase.

82. The low-latency touch sensitive device of claim 65, wherein the model comprises a model of a correction phase.

83. The low-latency touch sensitive device of claim 65, wherein the model comprises a model of a drop-down phase.

84. The method of claim 65, wherein the model utilizes changes in speed of the finger or object.

85. A low-latency touch sensitive device comprising:
a. a touch sensor capable of sensing location of a finger or object above a touch surface and creating data representative of current user input to the electronic device;
b. a memory having stored therein a model of user input from the touch sensor;
c. a processor configured to:
i. apply the model of user input to the data representative of current user input to create data reflecting a prediction of a future user input event;
ii. use the data reflecting the prediction of the future user input event to identify at least one particular response associated with the at least one predicted future user input event;
iii. cache in memory data useful to implement application state changes, the data comprising data reflecting at least one particular response associated with the predicted future user input; and,
iv. retrieve the cached data reflecting the at least one particular response from the memory of the electronic device and use the data to implement at least one of the application state changes.

86. The low-latency touch sensitive device of claim 85, wherein the processor is configured to retrieve the cached data from the memory of the electronic device in response to the predicted user input event.

87. The low-latency touch sensitive device of claim 85, wherein the processor is configured to retrieve the cached data from the memory of the electronic device prior to the predicted user input event.

88. The low-latency touch sensitive device of claim 85, wherein the device comprises hardware configured to retrieve the cached data and use the data.

89. The low-latency touch sensitive device of claim 85, wherein the device comprises software configured to retrieve the cached data and use the data.

90. The low-latency touch sensitive device of claim 85, wherein the processor is configured to predict a location of a touchdown.

91. The low-latency touch sensitive device of claim 85, wherein the processor is configured to predict a location of a touchup.

92. The low-latency touch sensitive device of claim 85, wherein the processor is configured to predict a gesture.

93. The low-latency touch sensitive device of claim 92, wherein the gesture comprises a multi-finger gesture.

94. The low-latency touch sensitive device of claim 85, wherein the processor is configured to predict a dragging path.

95. The low-latency touch sensitive device of claim 85, wherein the processor is configured to predict timing of the future user input.

96. The low-latency touch sensitive device of claim 85, wherein the processor is configured to compute one or more measures of probability indicative of confidence that the model associates with the predicted future event.

97. The method of claim 96, wherein the one or more measures of probability comprise a measure of probability that the future user input event will occur at a particular location and a measure of probability that the future user input event will occur at a particular time or time frame.

98. The low-latency touch sensitive device of claim 96, wherein the one or more measures of probability are used to determine data to be cached.

99. The low-latency touch sensitive device of claim 85, wherein the object is a stylus.

100. The low-latency touch sensitive device of claim 85, wherein the model is stored in the device as a table.

101. The low-latency touch sensitive device of claim 85, wherein the model comprises a model of a liftoff phase.

102. The low-latency touch sensitive device of claim 85, wherein the model comprises a model of a correction phase.

103. The low-latency touch sensitive device of claim 85, wherein the model comprises a model of a drop-down phase.

104. The low-latency touch sensitive device of claim 85, wherein the model utilizes changes in speed of the motion of the finger or object.

105. A low-latency touch sensitive device comprising:
a. a touch sensor capable of sensing location of a finger or object above a touch surface and creating data representative of current user input to the electronic device;
b. a memory having stored therein a model of user input from the touch sensor;
c. a processor configured to:
i. apply the model of user input to the data representative of current user input to create data reflecting a prediction of a future user input event;
ii. use the data reflecting the prediction of the future user input event to identify data useful to prepare the device or application for at least one particular event;
iii. cache in memory the data useful to prepare the device or application for the at least one particular event; and,
iv. retrieve the cached data useful to prepare the device or application for the at least one particular event in response to the predicted user input event and use the data to implement at least state change.

106. A low-latency touch sensitive device comprising:
a. a touch sensor capable of sensing location of a finger or object above a touch surface and creating data representative of current user input to the electronic device;
b. a memory having stored therein a model of user input from the touch sensor;
c. a processor configured to:
i. apply the model of user input to the data representative of current user input to create data reflecting a prediction of a future user input event;
ii. use the data reflecting the prediction of the future user input event to identify an error in interacting with the touch sensor;
iii. correct for the identified error.

107. The low-latency touch sensitive device of claim 106, wherein the error comprises human error.

108. The low-latency touch sensitive device of claim 106, wherein the human error comprises touching the touch sensor at a location other than an intended location.

109. The low-latency touch sensitive device of claim 106, wherein the error comprises a false touch.

110. A low-latency touch sensitive device comprising:
a. a touch sensor capable of sensing location of a finger or object above a touch surface and creating data representative of current user input to the electronic device;
b. a memory having stored therein a model of user input from the touch sensor;
c. a processor configured to:
i. apply the model of user input to the data representative of current user input to create data reflecting an approach;
ii. use the data reflecting the approach to map a contact area to pixels;
iii. use the map of contact area to pixels to identify a user input event.

111. The low-latency touch sensitive device of claim 110, wherein the processor is further configured to use a likely shape of a finger pressing into a screen to map a contact area to pixels.
